(19) United States
(12) Patent Application Publication
(10) Pub. No.: US 2025/0222755 A1
(43) Pub. Date: Jul. 10, 2025

(54) VIBRATION ISOLATION UNIT

(71) Applicant: Toyo Tire Corporation, Itami-shi (JP)

(72) Inventors: Toshiyuki Kitano, Itami-shi (JP); Akira Yasukawa, Itami-shi (JP); Takeshi Okamura, Itami-shi (JP); Shinji Horibe, Itami-shi (JP); Yuta Iwai, Itami-shi (JP)

(73) Assignee: Toyo Tire Corporation, Itami-shi (JP)

(21) Appl. No.: 18/945,632

(22) Filed: Nov. 13, 2024

(30) Foreign Application Priority Data
Jan. 10, 2024 (JP) 2024-001546

(51) Int. Cl. B60K 5/12

(52) U.S. Cl. CPC B60K 5/1291

(57) ABSTRACT

According to the vibration isolation unit, a first projection provided on an outer member is inserted through a first attachment hole in the stopper. By attaching the first fixing member larger than the first attachment hole to the end of the first projection, the stopper is fixed to the vibration isolation device. The stopper is sandwiched between the first fixing member and the outer member.

### BACKGROUND OF THE INVENTION

### 1. Field of the Invention

The present invention relates to a vibration isolation unit and, more specifically, to a vibration isolation unit in which detachment of a stopper and generation of unusual noise are suppressed.

### 2. Description of the Related Art

A known vibration isolation unit in the related art connects a power unit side, such as an engine, and a vehicle body side while suppressing transmission of vibration. This vibration isolation unit includes: a vibration isolation device, in which a shaft-like inner member and a tubular outer member are connected by a vibration isolation base made of an elastic material; and a stopper made of an elastic material and attached to the vibration isolation device. For example, the inner member is attached to the power unit side, and the outer member is attached to the vehicle body side.

Japanese Unexamined Patent Application Publication No. 2005-265179 discloses a stopper for buffering the collision between the axial ends of the outer member and a bracket provided on the power unit and attached to the inner member. The stopper is attached to the inner member by fitting the axial ends of the inner member to attachment holes extending through the stopper in the thickness direction.

However, the stopper disclosed therein, in which the axial ends of the inner member are simply fitted to the attachment holes in the stopper, has a problem in that the stopper is easily detached from the inner member during transportation of the vibration isolation unit before the inner member is fixed to the bracket. Furthermore, the vibration of the vehicle with respect to which the vibration isolation unit is assembled may move the stopper and cause hitting noise (unusual noise) or the like between the stopper and a surrounding member.

### SUMMARY OF THE INVENTION

The present invention has been made in view of the above-described problems, and an object thereof is to provide a vibration isolation unit in which detachment of a stopper and generation of unusual noise are suppressed.

A vibration isolation unit according to the present invention includes: a vibration isolation device including a shaft-like inner member, a tubular outer member, and a vibration isolation base made of an elastic material and connecting an outer peripheral surface of the inner member and an inner peripheral surface of the outer member, the inner member or the outer member being provided with a first projection; a stopper made of an elastic material and having a first attachment hole through which the first projection is inserted; and a first fixing member larger than the first attachment hole and attached to an end of the first projection to fix the stopper to the vibration isolation device. The stopper is sandwiched between the first fixing member and the inner member or the outer member having the first projection.

According to the vibration isolation unit of a first aspect, the first projection provided on the inner member or the outer member is inserted through the first attachment hole in the stopper. By attaching the first fixing member larger than the first attachment hole to the end of the first projection, the stopper is fixed to the vibration isolation device. This prevents the stopper from being detached from the vibration isolation device during, for example, transportation of the vibration isolation unit.

Furthermore, because the stopper is sandwiched between the first fixing member and the inner member or the outer member having the first projection, the stopper is prevented from moving in response to the vibration of the vehicle to which the vibration isolation unit is attached. This suppresses the occurrence of unusual noise due to the movement of the stopper.

The vibration isolation unit of a second aspect provides the following advantage in addition to the advantages provided by the vibration isolation unit of the first aspect. In a portion where the stopper is sandwiched between the first fixing member and the inner member or the outer member having the first projection, a distance between the first fixing member and the inner member or the outer member is equal to a thickness of the stopper in a no-load state. Hence, the stopper is sandwiched between the first fixing member and the inner member or the outer member with little compressive deformation. As a result, it is possible to facilitate the task of attaching the first fixing member to the first projection.

The vibration isolation unit of a third aspect provides the following advantage in addition to the advantages provided by the vibration isolation unit of the first aspect. The first fixing member is a mass member for adjusting the resonance frequency of the inner member or the outer member having the first projection. Because the stopper is fixed to the vibration isolation device with the first fixing member, which also serves as a mass member, the structure of the vibration isolation unit is simple, and an increase in cost due to the provision of the first fixing member is avoided.

The vibration isolation unit of a fourth aspect provides the following advantage in addition to the advantage provided by the vibration isolation unit of any of the first to third aspects. The stopper includes a peripheral surface portion that covers a part of the outer peripheral surface of the outer member in the circumferential direction, and the peripheral surface portion has a first attachment hole. When the stopper is fixed to the inner member, the stopper may be elongated by the relative displacement between the inner member and the outer member, caused by the deformation of the vibration isolation base. This may lower the durability of the stopper. In contrast, by attaching the first fixing member to the first projection protruding from the outer peripheral surface of the outer member to fix the stopper to the outer member, basically, the stopper is not elongated. Thus, the durability of the stopper is improved.

The vibration isolation unit of a fifth aspect provides the following advantage in addition to the advantage provided by the vibration isolation unit of the fourth aspect. The stopper includes a pair of end surface portions protruding radially inward from edges of the peripheral surface portion in an axial direction and covering parts of end surfaces of the outer member in the axial direction. The pair of end surface portions and the peripheral surface portion of the stopper form a U-shaped cross-section in the circumferential direction. Thus, the rigidity of the stopper is ensured. This prevents the stopper from being deformed so as to be radially separated from the outer peripheral surface of the outer member, at a position circumferentially separated from the fixing position between the vibration isolation device and the stopper (the vicinity of the first attachment hole). As a result, hitting noise due to re-contact between the outer peripheral surface of the outer member and the stopper is unlikely to occur.

The vibration isolation unit of a sixth aspect provides the following advantage in addition to the advantage provided by the vibration isolation unit of the fourth aspect. The stopper has a first attachment hole at one end and a second attachment hole at the other end in the circumferential direction. A second projection to be inserted through the second attachment hole protrudes from the outer peripheral surface of the outer member. A second fixing member larger than the second attachment hole is attached to the end of the second projection to fix the side of the stopper having the second attachment hole to the outer member. Thus, the second fixing member prevents the stopper from vibrating so as to rotate about the position where the stopper is fixed with the first fixing member. Hence, generation of hitting noise due to the vibration is suppressed.

The vibration isolation unit of a seventh aspect provides the following advantage in addition to the advantage provided by the vibration isolation unit of the sixth aspect. The stopper includes: a pair of circumferentially extending portions extending from the peripheral surface portion toward the other end in the circumferential direction and separated from each other in the axial direction of the outer member, and a pair of axially extending portions extending between the pair of circumferentially extending portions and separated from each other in the circumferential direction. A portion enclosed by the pair of circumferentially extending portions and the pair of axially extending portions is the second attachment hole. In this way, the other end of the stopper (the vicinity of the second attachment hole) has a ladder shape. When the stopper is attached to the outer member, this structure makes it easy to insert the first projection into the first attachment hole provided at one end of the peripheral surface portion in the circumferential direction, and then to insert the second projection into the second attachment hole while the ladder-shaped other end is stretched. Hence, the task of attaching the stopper to the outer member is easy.

The vibration isolation unit of an eighth aspect provides the following advantage in addition to the advantage provided by the vibration isolation unit of the sixth aspect. The second fixing member is a mass member for adjusting the resonance frequency of the outer member. Because the stopper is fixed to the outer member with the mass member, the structure of the vibration isolation unit is simple, and an increase in cost due to the provision of the second fixing member is avoided.

### BRIEF DESCRIPTION OF THE DRAWINGS

FIG. 1 is a perspective view of a vibration isolation unit according to a first embodiment.

FIG. 2 is an exploded perspective view of the vibration isolation unit.

FIG. 3 is a sectional view of the vibration isolation unit.

FIG. 4 is a sectional end view of the vibration isolation unit taken along line IV-IV in FIG. 3.

FIG. 5 is a sectional end view of the vibration isolation unit according to a second embodiment.

### DESCRIPTION OF THE PREFERRED EMBODIMENTS

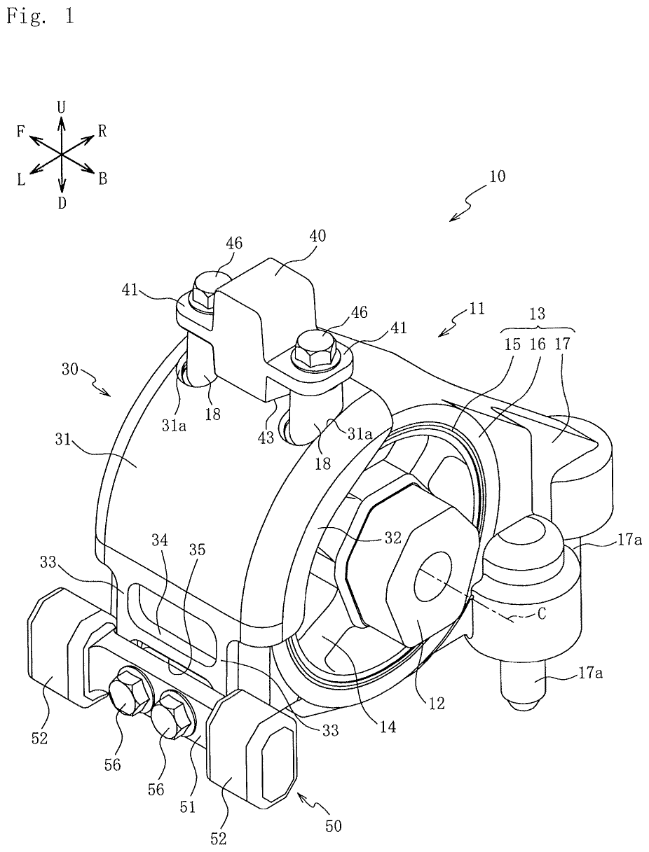

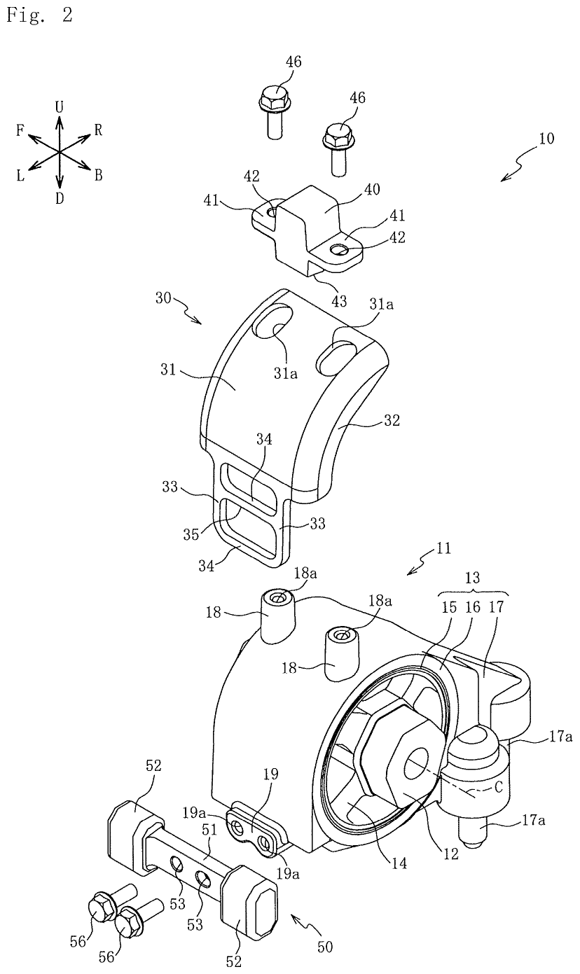

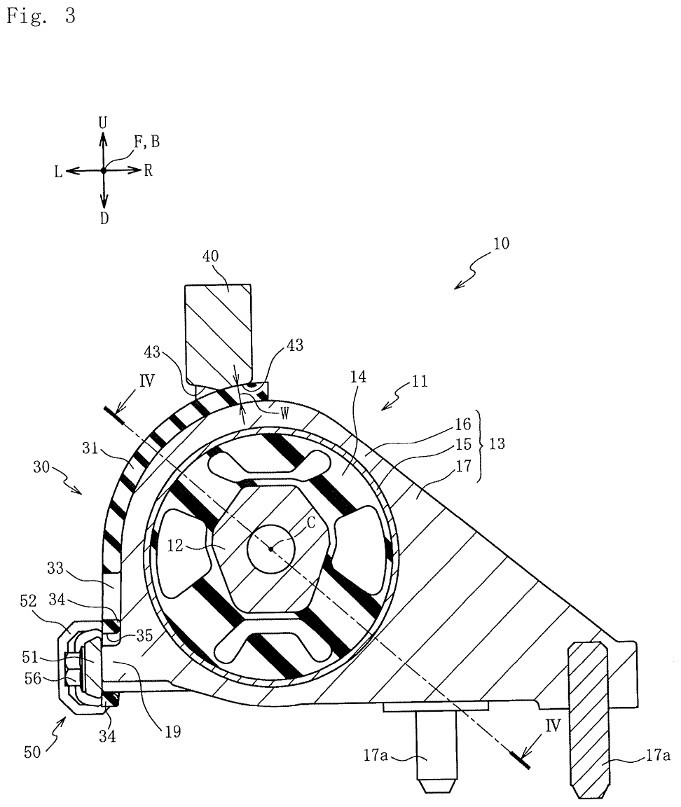

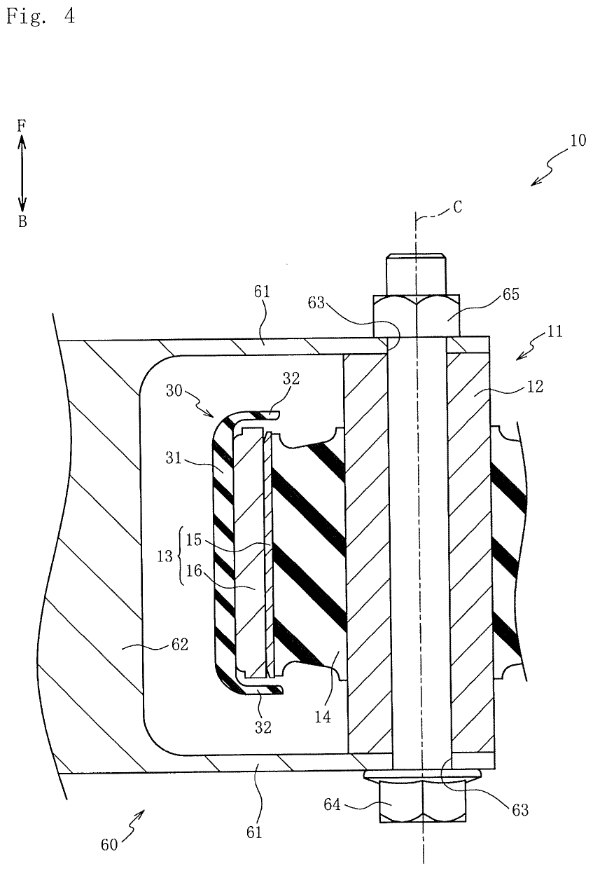

Hereinbelow, preferred embodiments will be described with reference to the accompanying drawings. FIG. 1 shows a vibration isolation unit 10 according to the first embodiment. FIG. 2 is an exploded perspective view of the vibration isolation unit 10. FIG. 3 is a sectional view of the vibration isolation unit 10 perpendicular to the axis C of an inner member 12. FIG. 4 is a sectional end view of the vibration isolation unit 10 taken along line IV-IV in FIG. 3.

In the drawings, arrows U, D, L, R, F, and B indicate the upward, downward, leftward, rightward, forward, and rearward directions of the vibration isolation unit 10, respectively. The up-down, right-left, and front-rear directions of the vibration isolation unit 10 do not necessarily coincide with those of the vehicle in which the vibration isolation unit 10 is installed.

As shown in FIG. 1, the vibration isolation unit 10 is an engine mount that connects a power unit, such as an engine or a motor (not shown), and a vehicle body (not shown) while suppressing transmission of vibration. The vibration isolation unit 10 includes a vibration isolation device 11 that connects a power unit side and a vehicle body side, a stopper 30 that covers a part of the vibration isolation device 11, and a first fixing member 40 and a second fixing member 50 for fixing the stopper 30 to the vibration isolation device 11.

The vibration isolation device 11 includes a shaft-like inner member 12, a tubular outer member 13 surrounding the outer peripheral side of the inner member 12, and a vibration isolation base 14 that connects the outer peripheral surface of the inner member 12 and the inner peripheral surface of the outer member 13. The vibration isolation base 14 is made of an elastic material such as rubber or a thermoplastic elastomer and connects the inner member 12 and the outer member 13 at four positions in the circumferential direction.

The inner member 12 is a tubular member made of a rigid material such as a steel material or an aluminum alloy. The axial direction of the inner member 12 coincides with the front-rear direction of the vibration isolation device 11. The inner peripheral surface of the inner member 12 has a circular cross-section centered on an axis C of the inner member 12, taken perpendicular to the axis C. The outer peripheral surface of the inner member 12 has a substantially hexagonal cross-section taken perpendicular to the axis C.

As shown in FIG. 4, the inner member 12 is connected to the power unit side via a bracket 60. The bracket 60 includes a pair of side portions 61 facing each other in the thickness direction and a connecting portion 62 connecting the pair of side portions 61. The connecting portion 62 is fixed to the power unit side.

The inner member 12 is disposed between the pair of side portions 61 in the front-rear direction (axial direction), and the connecting portion 62 is located on the upper left side of the outer member 13. In this state, a bolt 64 is inserted through the inner member 12 and through-holes 63 provided in the side portions 61, and a nut 65 is fastened to the bolt 64 to fix the inner member 12 to the bracket 60.

As shown in FIGS. 2 and 3, the outer member 13 includes a cylindrical portion 15 to which the vibration isolation base 14 is connected, a thick tubular portion 16 into which the cylindrical portion 15 is press-fitted, and a fixing portion 17 via which the thick tubular portion 16 is fixed to the vehicle body side. The cylindrical portion 15 is a cylindrical member centered on the axis C and is made of a rigid material such as a steel material or an aluminum alloy. The vibration isolation base 14 is bonded by vulcanization to the inner peripheral surface of the cylindrical portion 15 and the outer peripheral surface of the inner member 12.

The thick tubular portion 16 is a cylindrical member made of an aluminum alloy and thicker than the cylindrical portion 15. The thick tubular portion 16 and the cylindrical portion 15 have substantially the same axial dimension, which is smaller than the axial dimension of the inner member 12. The axial end surfaces of the inner member 12 are located on the axially outer side of the end surfaces of the thick tubular portion 16 and the cylindrical portion 15 in the axial direction.

Two first projections 18 protrude upward from the upper side of the outer peripheral surface of the thick tubular portion 16. The first projections 18 are cylindrical portions each having a screw hole 18a in the end (upper end). The first projections 18 are arranged side-by-side in the front-rear direction.

A second projection 19 having a substantially rectangular parallelepiped shape protrudes leftward from the lower left side of the outer peripheral surface of the thick tubular portion 16. The second projection 19 has two screw holes 19a arranged side-by-side in the front-rear direction at the end (left end) thereof.

The fixing portion 17 is integrally molded with the thick tubular portion 16 so as to protrude from the outer peripheral surface of the thick tubular portion 16 toward the lower right. The bracket 60 is fixed to the vehicle body side with a plurality of screw parts 17a provided in the fixing portion 17.

As shown in FIGS. 2 and 4, the stopper 30 buffers the collision between the outer member 13 and the bracket 60 when the outer member 13 and the bracket 60 are relatively displaced by the deformation of the vibration isolation base 14. The stopper 30 is made of an elastic material such as rubber or a thermoplastic elastomer.

The stopper 30 includes: a peripheral surface portion 31 covering a part of the outer peripheral surface of the outer member 13 (thick tubular portion 16) in the circumferential direction; a pair of end surface portions 32 projecting radially inward (toward the axis C) from the edges of the peripheral surface portion 31 in the front-rear direction; a pair of circumferentially extending portions 33 extending in the circumferential direction from the peripheral surface portion 31 and separated from each other in the front-rear direction; and a pair of axially extending portions 34 extending between the pair of circumferentially extending portions 33 and separated from each other in the circumferential direction.

The peripheral surface portion 31 is a plate-like portion that covers a predetermined area on the upper left side of the outer peripheral surface of the outer member 13. In other words, the peripheral surface portion 31 is provided at a portion where the outer member 13 and the bracket 60 face each other in the radial direction. The peripheral surface portion 31 can buffer the collision occurring when the outer member 13 and the bracket 60 are relatively displaced in the radial direction.

The peripheral surface portion 31 has two substantially circular first attachment holes 31a penetrating in the up-down direction, at one end (upper end) thereof in the circumferential direction. The first attachment holes 31a are slightly larger than the first projections 18 so as to allow the first projections 18 to pass therethrough. The two first attachment holes 31a are arranged side-by-side in the front-rear direction so as to allow the two first projections 18 arranged side-by-side in the front-rear direction to pass therethrough.

The end surface portions 32 are plate-like portions that cover upper left portions of the axial end surfaces of the outer member 13. In other words, the end surface portions 32 are provided at portions where the outer member 13 and the bracket 60 face each other in the front-rear direction (axial direction). The end surface portions 32 can buffer the collision occurring when the outer member 13 and the bracket 60 are relatively displaced in the front-rear direction.

The pair of circumferentially extending portions 33 extend in parallel from the peripheral surface portion 31 toward the other end (lower side) in the circumferential direction. A pair of axially extending portions 34 extend in parallel between the circumferentially extending portions 33 at the lower end and substantially middle portion thereof in the circumferential direction. The pair of circumferentially extending portions 33 and the pair of axially extending portions 34 form a ladder-like part at the other end (lower end) of the stopper 30 in the circumferential direction.

The stopper 30 has a substantially rectangular second attachment hole 35, which is a portion enclosed by the pair of circumferentially extending portions 33 and the pair of axially extending portions 34. The second attachment hole 35 is slightly larger than the second projection 19 so as to allow the second projection 19 to pass therethrough.

Because the portion of the stopper 30 in the vicinity of the second attachment hole 35 has a ladder shape, the portion is more easily deformed than the peripheral surface portion 31 and the end surface portions 32. When the stopper 30 is attached to the outer member 13, this structure makes it easy to allow the first projections 18 to pass through the first attachment holes 31a provided in the upper end of the stopper 30 and then allow the second projection 19 to pass through the second attachment hole 35, while the vicinity of the ladder-shaped second attachment hole 35 is stretched. Hence, the task of attaching the stopper 30 to the outer member 13 is easy.

In a state in which the stopper 30 is attached to the outer member 13 in this way, the first fixing member 40 and the second fixing member 50 are attached to the outer member 13 to fix the stopper 30 to the outer member 13.

As shown in FIGS. 1 and 2, the first fixing member 40 is a substantially rectangular parallelepiped member made of a rigid material such as a steel material or an aluminum alloy. Flanges 41 protrude from the middle parts, in the up-down direction, of the front and rear surfaces of the first fixing member 40.

The flanges 41 are plate-like portions perpendicular to the up-down direction. The flanges 41 each have a through-hole 42 in the center thereof. The flanges 41 are placed on the ends of the first projections 18, and bolts 46 inserted through the through-holes 42 are screwed into screw holes 18a in the first projections 18 to attach the first fixing member 40 to the outer member 13.

Because the first fixing member 40 is sufficiently larger than the first attachment holes 31a through which the first projections 18 are inserted, the first projections 18 are unlikely to come off from the first attachment holes 31a. In other words, the first fixing member 40 fixes the portion of the stopper 30 in the vicinity of the first attachment holes 31a to the outer member 13. This prevents the stopper 30 from being detached from the vibration isolation device 11 during, for example, transportation in which the vibration isolation unit 10 is not attached to the vehicle body side or the power unit side.

In particular, in this embodiment, the first fixing member 40 is attached so as to connect the two first projections 18. Hence, the first projections 18 are even unlikely to come off from the first attachment holes 31a. This further prevents the stopper 30 from being detached from the vibration isolation device 11 during transportation or the like.

The first fixing member 40 is a mass member for adjusting the resonance frequency of the outer member 13 to which the first fixing member 40 is attached, and extends upward and downward from the flanges 41 to ensure the mass. Because the stopper 30 is fixed to the outer member 13 with the first fixing member 40, which also serves as a mass member, the structure of the vibration isolation unit 10 is simple, and an increase in cost due to the provision of the first fixing member 40 is avoided.

As shown in FIGS. 1 and 3, in a state in which the stopper 30 is fixed to the outer member 13 with the first fixing member 40, the stopper 30 is sandwiched between a lower surface 43 of the first fixing member 40 and the outer peripheral surface of the outer member 13. This prevents the stopper 30 from moving in response to the vibration of the vehicle to which the vibration isolation unit 10 is attached. Specifically, this prevents the stopper 30 from vibrating vertically along the first projections 18 and sliding along the outer peripheral surface of the outer member 13. As a result, it is possible to suppress hitting noise and rubbing noise between the stopper 30 and the vibration isolation device 11, the first fixing member 40, and the like.

In the portion where the stopper 30 is sandwiched in this way, the distance W between the lower surface 43 of the first fixing member 40 and the outer peripheral surface of the outer member 13 is equal to the thickness of the stopper 30 in a no-load state. The term “equal” does not necessarily mean “exactly equal”. Taking errors into consideration, the term “equal” is used when the difference between the distance W and the height of the stopper 30 in a no-load state is less than or equal to 1 mm. Alternatively, to ensure that the stopper 30 is in contact with both the first fixing member 40 and the outer member 13, the term “equal” may be used when the thickness of the stopper 30 in a no-load state is larger than the distance W by 0 to 1 mm.

With this dimensional relationship, the stopper 30 is sandwiched between the first fixing member 40 and the outer member 13 with little compressive deformation. As a result, when the bolts 46 are screwed into the screw holes 18a of the first projections 18, a reaction force caused by the compressive deformation of the stopper 30 is unlikely to occur. Thus, the task of attaching the first fixing member 40 to the first projections 18 is easy.

The lower surface 43 of the first fixing member 40 is curved toward the center in the right-left direction, along the outer peripheral surface of the outer member 13. The distance W between the curved lower surface 43 and the outer peripheral surface of the outer member 13 is substantially constant in the circumferential direction. Hence, when the stopper 30 is sandwiched between the lower surface 43 and the outer peripheral surface of the outer member 13, a certain contact area therebetween is ensured. As a result, it is possible to further suppress movement of the stopper 30 due to, for example, vibration of the vehicle, and generation of unusual noise due to the movement.

The first fixing member 40 including the lower surface 43 curved in this manner is laterally symmetrical as a whole. Hence, the stopper 30 is sandwiched between the lower surface 43 and the outer peripheral surface of the outer member 13 even when the first fixing member 40 is attached to the outer member 13 in a laterally reversed manner. Thus, when the first fixing member 40 is to be attached to the outer member 13, there is no need to check the lateral direction of the first fixing member 40. Thus, the task of attaching the first fixing member 40 is easy.

The portion of the stopper 30 fixed to the outer member 13 with the first fixing member 40 has a U-shaped cross-section in the circumferential direction, which is defined by the peripheral surface portion 31 and the pair of end surface portions 32. The stopper 30 also has a U-shaped cross-section in the circumferential direction over a predetermined area in the circumferential direction from the aforementioned fixing position. Thus, the rigidity of the stopper 30 is ensured. This prevents the stopper 30 from being deformed so as to be radially separated from the outer peripheral surface of the outer member 13, at a position separated from the above-described fixing position in the circumferential direction (the vicinity of the first attachment holes 31a). As a result, hitting noise due to re-contact between the outer peripheral surface of the outer member 13 and the stopper 30 is unlikely to occur.

The second fixing member 50 is a bar-shaped member made of a rigid material such as a steel material or an aluminum alloy. The second fixing member 50 includes a plate portion 51 extending in the front-rear direction and perpendicular to the right-left direction, and substantially octagonal weight portions 52 provided at front and rear ends of the plate portion 51.

The plate portion 51 has two through-holes 53 arranged side-by-side in the front-rear direction. The plate portion 51 is placed on the end of the second projection 19, and two bolts 56 inserted through the through-holes 53 are screwed into the screw holes 19a in the second projection 19 to attach the second fixing member 50 to the outer member 13.

Because the second fixing member 50 is sufficiently larger than the second attachment hole 35 through which the second projection 19 is inserted, the second projection 19 is unlikely to come off from the second attachment hole 35. In other words, the portion of the stopper 30 in the vicinity of the second attachment hole 35 is fixed to the outer member 13 with the second fixing member 50. This further prevents the stopper 30 from being detached from the vibration isolation device 11 during transportation of the vibration isolation unit 10 or the like.

In the vibration isolation unit 10, the upper end of the stopper 30 in the circumferential direction is fixed with the first fixing member 40, and the lower end of the stopper 30 in the circumferential direction is fixed with the second fixing member 50. Thus, the second fixing member 50 prevents the stopper 30 from vibrating so as to rotate about the position where the stopper 30 is fixed with the first fixing member 40. Hence, generation of hitting noise due to the vibration is suppressed.

A portion of the stopper 30 in the vicinity of the second attachment hole 35 is sandwiched between the second fixing member 50 and the outer peripheral surface of the outer member 13. Thus, the second fixing member 50 further prevents the stopper 30 from vibrating so as to rotate about the position where the stopper 30 is fixed with the first fixing member 40.

As described above, the lower end of the stopper 30 in the circumferential direction, fixed by the second fixing member 50, has a ladder shape and is easily deformed. When the stopper 30 is deformed, the deformation is easily absorbed by the ladder-shaped portion. Thus, deformation of the peripheral surface portion 31 and the end surface portions 32 mainly having a buffering function is suppressed. As a result, fluctuation of buffering characteristics and generation of unusual noise due to the deformation of the stopper 30 are suppressed.

The second fixing member 50 is a mass member for adjusting the resonance frequency of the outer member 13 to which the second fixing member 50 is attached, and has weight portions 52 for providing the mass. Because the stopper 30 is fixed to the outer member 13 with the second fixing member 50, which also serves as a mass member, the structure of the vibration isolation unit 10 is simple, and an increase in cost due to the provision of the second fixing member 50 is avoided.

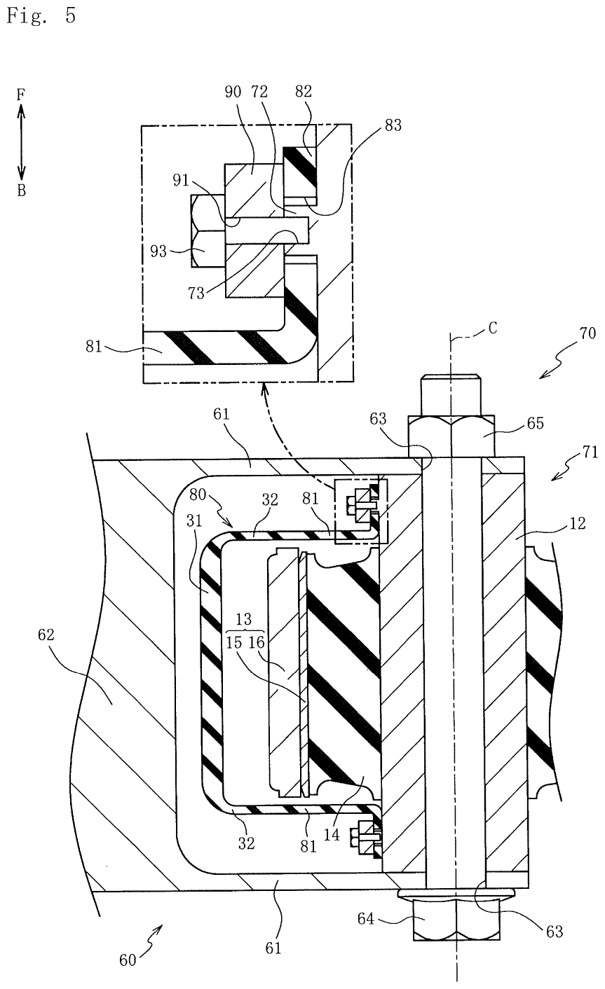

Next, a second embodiment will be described with reference to FIG. 5. In the first embodiment, the case where the stopper 30 is fixed to the outer member 13 has been described. In the second embodiment, a case where a stopper 80 is fixed to the inner member 12 will be described. The same reference numerals denote the same parts as those in the first embodiment, and the description thereof will be omitted.

FIG. 5 is a sectional end view of a vibration isolation unit 70 according to the second embodiment, showing a sectional end surface taken at the same position as that in FIG. 4. The vibration isolation unit 70 includes a vibration isolation device 71 that connects the power unit side and the vehicle body side, a stopper 80 that covers a part of the vibration isolation device 71, and first fixing members 90 for fixing the stopper 80 to the vibration isolation device 71.

The vibration isolation device 71 is the same as the vibration isolation device 11 according to the first embodiment, except that the first projections 18 and the second projection 19 are omitted from the outer member 13, and first projections 72 are provided on the inner member 12.

The first projections 72 protrude toward the connecting portion 62 of the bracket 60 from the outer peripheral surfaces of the inner member 12, on both sides in the front-rear direction of the vibration isolation base 14. The first projections 72 are cylindrical portions each having a screw hole 73 at the end.

The stopper 80 does not have the first attachment holes 31a, the second attachment hole 35, the circumferentially extending portions 33, and the axially extending portions 34 provided in the stopper 30 in the first embodiment, and has the peripheral surface portion 31 and the pair of end surface portions 32. The stopper 80 further includes extension portions 81 extending radially inward (toward the axis C) from portions of the end surface portions 32 in the circumferential direction, and bent portions 82 bent substantially perpendicularly outward in the axial direction (front-rear direction) from the radially inner edges of the extension portions 81. The stopper 80 is symmetrical in the front-rear direction.

The bent portions 82 are plate-like portions to be superposed on portions of the outer peripheral surface of the inner member 12 in the vicinity of the first projections 72, and have substantially circular first attachment holes 83 extending in the thickness direction. The first attachment holes 83 are slightly larger than the first projections 72 so as to allow the first projections 72 to pass therethrough.

The first fixing members 90 are attached to the ends of the first projections 72 inserted through first attachment holes 83 to fix the stopper 80 to the inner member 12. The first fixing members 90 are plate-like members made of a rigid material such as a steel material or an aluminum alloy.

The first fixing members 90 each have a through-hole 91 in the center thereof. The first fixing members 90 are placed on the ends of the first projections 72, and screws 93 inserted through the through-holes 91 are screwed into the screw holes 73 in the first projections 72 to attach the first fixing members 90 to the inner member 12.

Because the first fixing members 90 are sufficiently larger than the first attachment holes 83 through which the first projections 72 are inserted, the first projections 72 are unlikely to come off from the first attachment holes 83. In other words, the first fixing members 90 fix the portion of the stopper 80 in the vicinity of the first attachment holes 83 to the inner member 12. This prevents the stopper 80 from being detached from the vibration isolation device 71 during, for example, transportation in which the vibration isolation unit 70 is not attached to the vehicle body side or the power unit side.

Furthermore, the bent portions 82 of the stopper 80 are sandwiched between the first fixing members 90 and the outer peripheral surface of the inner member 12. This prevents the stopper 80 from moving in response to the vibration of the vehicle to which the vibration isolation unit 70 is attached. As a result, it is possible to suppress hitting noise or rubbing noise between the stopper 80 and the vibration isolation device 71, the first fixing members 90, or the like.

In the portions where the bent portions 82 of the stopper 80 are sandwiched in this way, the distance between the first fixing members 90 and the outer peripheral surface of the inner member 12 is equal to the thickness of the bent portions 82 in the non-load state. With this dimensional relationship, the bent portions 82 is sandwiched between the first fixing members 90 and the inner member 12 with little compressive deformation. As a result, as in the first embodiment, the task of attaching the first fixing members 90 to the first projections 72 is easy.

In a state in which the stopper 80 is fixed to the inner member 12 with the first fixing members 90, and in a no-load state of the vibration isolation unit 70, the peripheral surface portion 31 of the stopper 80 is radially separated from the outer peripheral surface of the outer member 13. Thus, when a load is input to the vibration isolation unit 70 to deform the vibration isolation base 14 and displace the outer member 13 toward the connecting portion 62 relative to the inner member 12, the outer member 13 does not come into contact with the stopper 80 if the amount of displacement is small. Hence, it is possible to prevent the stopper 80 from being elongated in the radial direction due to the above-described displacement, and to ensure the durability of the stopper 80.

In contrast, in the vibration isolation unit 10 of the first embodiment, the stopper 30 that covers a portion of the outer peripheral surface of the outer member 13 is fixed to the outer member 13. Hence, in the first embodiment, basically, the stopper 30 is not elongated by the above-described relative displacement. Thus, the durability of the stopper 30 is improved.

Although the present invention has been described on the basis of the embodiments, the present invention is not limited to the embodiments, and it can be easily inferred that various improvements and modifications can be made without departing from the scope of the present invention. For example, the shapes, dimensions, and materials of the respective parts of the vibration isolation device 11, 71, the stopper 30, 80, the first fixing member 40, 90, the second fixing member 50, and the bracket 60 are merely examples. Various shapes, dimensions, and materials may of course be adopted.

For example, the inner member 12 may be formed in a cylindrical shape, a columnar shape, a prismatic shape, or the like. In this specification, tubular and columnar shapes are collectively referred to as a shaft shape. The method of fixing the inner member 12 and the bracket 60 may be changed as appropriate depending on the shape of the inner member 12. The cylindrical portion 15 of the outer member 13 may be omitted, and the vibration isolation base 14 may be directly connected to the inner peripheral surface of the thick tubular portion 16.

The inner member 12 and the outer member 13 may be connected to each other by the vibration isolation base 14 at three or less, or five or more positions, instead of four positions in the circumferential direction. Alternatively, the inner member 12 and the outer member 13 may be connected to each other by the vibration isolation base 14 over the entire circumference.

In the above embodiment, the inner member 12 is fixed to the power unit side via the bracket 60, and the outer member 13 is fixed to the vehicle body side. However, the structure is not necessarily limited to this. The inner member 12 may be fixed to the vehicle body side via the bracket 60, and the outer member 13 may be fixed to the power unit side.

In the first embodiment, the case where the first fixing member 40 and the second fixing member 50 are mass members for adjusting the resonance frequency of the outer member 13 has been described. However, the structure is not limited to this. The first fixing member 40 and the second fixing member 50 may be a stay for connecting the outer member 13 and the vehicle body, or a stay to which harnesses (various wires) are attached. Furthermore, the first fixing members 90 attached to the inner member 12 as in the second embodiment may be mass members for adjusting the resonance frequency of the inner member 12, or may be stays.

In the first embodiment, the case where the first fixing member 40 is symmetrical has been described. However, the present invention is not necessarily limited thereto, and the first fixing member 40 may be asymmetrical. For example, the lower surface 43 of the first fixing member 40 may be curved along the outer peripheral surface of the outer member 13 over the entire length in the right-left direction. When the stopper 30 is sandwiched between the lower surface 43 and the outer member 13, this structure further increases the contact area among them. As a result, it is possible to further suppress the movement of the stopper 30 in response to, for example, the vibration of the vehicle, and to further suppress generation of unusual noise due to the movement.

In the first embodiment, the case where the portion of the stopper 30 in the vicinity of the second attachment hole 35 is sandwiched between the second fixing member 50 and the outer member 13 has been described. However, the present invention is not necessarily limited thereto. For example, the dimensions may be adjusted such that the stopper 30 is not sandwiched between the second fixing member 50 and the outer member 13.

In the first embodiment, the stopper 30 includes the circumferentially extending portions 33 and the axially extending portions 34. However, the present invention is not necessarily limited thereto. These may be omitted from the stopper 30, and the second attachment hole 35 may be formed so as to penetrate the peripheral surface portion 31. Furthermore, the circumferentially extending portions 33, the axially extending portions 34, the second attachment hole 35, the second projection 19, and the second fixing member 50 may be omitted. That is, the stopper 30 may be fixed to the outer member 13 only with the first fixing member 40.

### DESCRIPTION OF REFERENCE NUMERALS

10, 70 vibration isolation unit
11, 71 vibration isolation device
12 inner member
13 outer member
14 vibration isolation base
18, 72 first projection
19 second projection
30, 80 stopper
31 peripheral surface portion
31a, 83 first attachment hole
32 end surface portion
33 circumferentially extending portion
34 axially extending portion
35 second attachment hole
40, 90 first fixing member
50 second fixing member

What is claimed is:

1. A vibration isolation unit comprising:
a vibration isolation device including a shaft-like inner member, a tubular outer member, and a vibration isolation base made of an elastic material and connecting an outer peripheral surface of the inner member and an inner peripheral surface of the outer member, the inner member or the outer member being provided with a first projection;
a stopper made of an elastic material and having a first attachment hole through which the first projection is inserted; and
a first fixing member larger than the first attachment hole and attached to an end of the first projection to fix the stopper to the vibration isolation device,
wherein the stopper is sandwiched between the first fixing member and the inner member or the outer member having the first projection.

2. The vibration isolation unit according to claim 1, wherein, in a portion where the stopper is sandwiched between the first fixing member and the inner member or the outer member having the first projection, a distance between the first fixing member and the inner member or the outer member is equal to a thickness of the stopper in a no-load state.

3. The vibration isolation unit according to claim 1, wherein the first fixing member is a mass member for adjusting a resonance frequency of the inner member or the outer member having the first projection.

4. The vibration isolation unit according to claim 1, wherein
the stopper includes a peripheral surface portion that covers a part of an outer peripheral surface of the outer member in a circumferential direction and that has the first attachment hole, and
the first projection protrudes from the outer peripheral surface of the outer member.

5. The vibration isolation unit according to claim 4, wherein the stopper includes a pair of end surface portions protruding radially inward from edges of the peripheral surface portion in an axial direction and covering parts of end surfaces of the outer member in the axial direction.

6. The vibration isolation unit according to claim 4, wherein
the stopper has the first attachment hole at one end thereof in the circumferential direction and a second attachment hole at the other end thereof in the circumferential direction,
a second projection inserted through the second attachment hole protrudes from the outer peripheral surface of the outer member, and
a second fixing member larger than the second attachment hole is attached to an end of the second projection to fix a side of the stopper having the second attachment hole to the outer member.

7. The vibration isolation unit according to claim 6, wherein
the first attachment hole is provided at one end of the peripheral surface portion in the circumferential direction thereof,
the stopper includes:
a pair of circumferentially extending portions extending from the peripheral surface portion toward the other end in the circumferential direction and separated from each other in the axial direction of the outer member; and
a pair of axially extending portions extending between the pair of circumferentially extending portions and separated from each other in the circumferential direction, and
a portion enclosed by the pair of circumferentially extending portions and the pair of axially extending portions is the second attachment hole.

8. The vibration isolation unit according to claim 6, wherein the second fixing member is a mass member for adjusting a resonance frequency of the outer member.
